(19) United States
(12) Patent Application Publication
(10) Pub. No.: US 2003/0231960 A1
(43) Pub. Date: Dec. 18, 2003

(54) Fan blade assembly

(75) Inventors: Kikuo Asada, Shizuoka Prefecture (JP); Ryuichi Kusanagi, Shizuoka Prefecture (JP); Haruyasu Ito, Shizuoka Prefecture (JP); Kazunori Takikawa, Shizuoka Prefecture (JP); Hiroshi Kanazashi, Shizuoka Prefecture (JP); Yoshiyuki Mita, Shizuoka Prefecture (JP)

Correspondence Address: CASELLA & HESPOS, 274 MADISON AVENUE, NEW YORK, NY, 10016

(73) Assignee: Usui Kokusai Sangyo Kaisha Limited, Sunto-gun (JP)

(21) Appl. No.: 10/171,279

(22) Filed: Jun. 12, 2002

Related U.S. Application Data
(60) Provisional application No. 60/388,593, filed on Jun. 12, 2002.

(51) Int. Cl. F03B 3/12

(52) U.S. Cl. 416/210 R

(57) ABSTRACT

A fan comprising resin blades which prevents the generation of cracks due to stress generated by the concentration of stress during rotation and heat contraction of the material, and which has improved fan durability and cooling performance, is provided.

A fan of configuration in which each resin blade is independently provided on a metal disc, characterized in that a separate metal spider part is attached to the above-mentioned metal disc by welding or the use of a rivet or a bolt or the like, and the resin blade is integrally molded to said spider part.

A fan with improved fan durability and cooling performance can be provided at lower cost.

### DETAILED DESCRIPTION OF THE INVENTION

1. Technical Field of the Invention

The present invention relates to a fan comprising resin blades for, by way of example, fluid type fan coupling apparatus which, in the wake of temperature changes in the external region or input rotational changes, afford the control of the rotation of engine cooling fans of, for example, plastic fans used in general industry and the home or automobiles, and which continuously supply and automatically adjust the volume of cooling wind to the engine in response to the operation state thereof.

2. Prior Art

Fluid type fan coupling apparatus which control, for example, the engine fan for the engine cooling water of a cooling radiator in an automobile, are generally of a structure in which the interior part of a housing, to which a cooling fan is attached, is divided by a partition plate into an oil reservoir chamber and a torque transmission chamber in which a drive disc is disposed, and a dam and, communicating therewith, a circulating discharge passage which leads from the torque transmission chamber side to the oil reservoir chamber side, are formed in one part of the inner circumferential wall surface of the housing opposing the outer circumferential wall part of the drive disc on which the oil collects and is held during rotation, and a valve member, which opens an oil supply adjustment hole provided in the above-mentioned partition plate when the temperature of the external region thereof exceeds a set value and closes the above-mentioned oil supply adjustment hole below a set value, is provided in the interior part in such a way as to be interlocked with the deformation that accompanies the temperature changes of a temperature sensitive body provided in the above-mentioned housing, wherein the effective contact surface area of the oil on the torque transmission gap part in the torque transmission chamber is increased and decreased to control the torque transmission from the rotating shaft body side to the housing side of the side to be driven and to rotate the cooling fan.

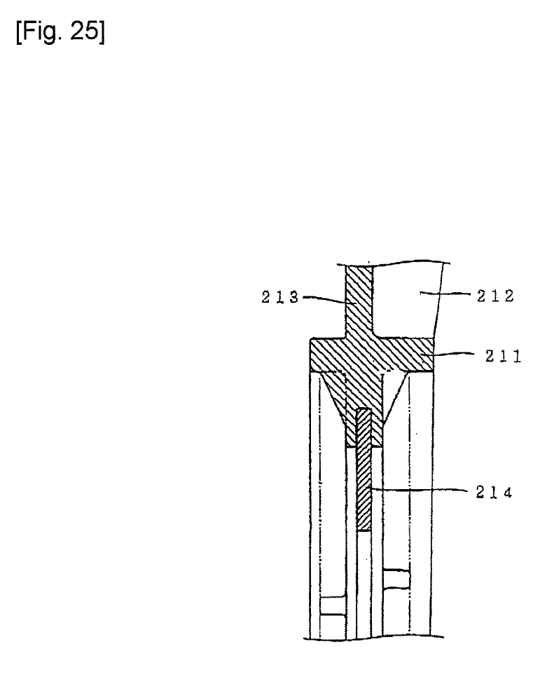

Although cooling fans for the fluid type fan coupling apparatus of configurations such as this may be either metal or resin, by virtue of the fact that resin fans are lighter than metal fans and, that they have better vibration absorption characteristics, produce less noise and, that they are more economical, plastic fans are more widely used. In FIG. 24 and FIG. 25, which show illustrative examples of this kind of resin fan, a large number (normally of the order of 4 to 10) of fan blades 312 are arranged on the outer circumferential surface of an annular fan boss part 311 and a large number (normally of the order of 4 to 10) on the outer circumferential surface of an annular fan boss part 311. The fan is formed from a plastic (synthetic resin material) injection molded body, wherein the joint part of the fan blade 312 is attached with a certain attack angle and at a prescribed angle of incline to the axis of the boss part 311, and the fan blade 312 itself is formed in a shape that twists from the joint part 313 to the tip-end part thereof with a gradually decreasing attack angle. The fan is attached to a metal insert 314 affixed to the above-mentioned housing. It will be noted that the metal insert 314 may comprise an annular flange part in which the tip-end part bends up perpendicularly, or it may be flat without comprising a flange part.

It will be noted that PP, PPG (G: glass fiber), N (Nylon) or NG (G: glass fiber) of which, in terms of strength, PP has the lowest strength and the strengths thereof increase in the order PPG, N, NG, and of which, in terms of cost, PP is the lowest and the costs thereof increase in the order PPG, N, NG, may be used as the material for the blade of the above-noted resin fan.

It is generally the case that, in a resin fan for, by way of example, a fluid type coupling apparatus as described above, the resin blade is integrally molded to a steel plate spider part. Although, in the manufacture thereof, the resin blade is molded at a melting point of around 270° C. and then cooled, the heat generated from the fan coupling device when the engine is in use is transferred by way of the insert which causes the resin blade to rise to a high temperature, wherein the temperature of the resin of the section close to the fan coupling apparatus, that is to say, the blade joint part, reaches a high temperature of approximately 230° C. For this reason, due to the difference in thermal expansion coefficient between the steel and the resin (the thermal expansion coefficient of the steel is 1/10 that of the resin), an excessive stress is generated on the section of the resin blade close to the fan coupling apparatus. In addition, because of twist due to the wind pressure and the centrifugal forces along with the bending moment due to vibration that act on the fan blades and the like during rotation, the stress is concentrated on the joint part of said blade. It is possible that this stress, which is largely generated in the region of a baffle hole of the boss part which, notably, provides the force for turning the blade, will, in combination with the large stresses arising from the large centrifugal forces produced as a result of the large capacity of the boss part itself, impart an effect on the strength thereof and create cracks in the boss part between one blade and another. In addition, if a boss part is provided, the cooling is inadequate because the cooling wind about the fan coupling apparatus is retarded, the wind volume is decreased and the wind speed is lowered, and this invites a rise in the temperature of the bearings and the silicon oil of the fan coupling apparatus and is a cause of the lowering of the durability thereof.

On the other hand, Japanese Utility Model Application No. Showa 48-20657, which was proposed by the applicant of this invention, describes, in a fan in which the attachment part for an opposing member is made from metal and the blade is made of a resin, a fan of a configuration in which each of the above-mentioned resin blades are provided independently in the above-mentioned metal attachment part. That is to say, this fan, which is configured by the integral molding of the resin blades to a spider part integrally provided in a metal disc, is advantageous in that, by virtue of the fact that, as no annular boss is provided, the blades can be individually deformed in the wake of temperature changes and speed changes, the durability of the fan is improved, there is no breakdown of the boss part due to centrifugal forces and, furthermore, the cooling performance is improved because the cooling wind around the fan coupling apparatus is able to be caused to flow diagonally easily whereby the wind volume and wind speed are increased.

However, there are problems in the use of a fan of this type in that, for example, the wind volume and wind pressure cannot be effectively increased because of the difficulty in increasing the number of blades and, by virtue of the fact that the degree of freedom for the non-uniformity of blade interval is low, a lowering of the pitch noise cannot be achieved and, a wide space exists between the blades, the noise of the engine room permeates through the front surface of the vehicle without being reflected on the rear surface of the blades wherein, accordingly, a loud engine noise is produced.

The present invention, which is designed in order to obviate the above-noted problems, is one which, in a fan of a configuration in which each of the resin blades are independently provided on a metal disc, proposes a fan comprising resin blades that provides the effects whereby, for example, the generation of cracks due to the stress generated by heat contraction of the material or stress concentration during fan rotation is prevented and improvements in the durability of the fan and the performance thereof are achieved and, by virtue of the fact that the blade number can be easily increased, the wind volume and wind pressure are able to be effectively increased, the degree of freedom for the non-uniformity of blade interval can be increased, a decrease of the pitch noise can be achieved and, furthermore, the engine noise from the front surface of the automobile can be reduced.

### Means to Solve the Problems

A first embodiment mode of the fan comprising resin blades pertaining to the present invention is, in a fan of a configuration in which each of the resin blades are independently provided on a metal disc, characterized in that it is configured by the attachment of a separate spider metal part to the above-mentioned metal disc by welding or the use of a rivet or a bolt or the like, and the integral molding of the resin blade to said spider part;

a second embodiment mode thereof is characterized in that a metal spider part formed as two pieces at the leading edge and rear edge of one resin blade is attached to a metal disc by welding or the use of a rivet or a bolt or the like, and the resin blade is integrally molded to said 2-piece spider part;

a third embodiment mode thereof is characterized in that it is configured by the integral molding of a high-strength resin spider part to a metal disc, and the integral molding of a resin blade to said spider part;

a fourth embodiment mode thereof is characterized in that it is configured by the attachment of a high-strength resin spider part to a metal disc using a rivet or a bolt or the like, and the integral molding of the above-mentioned resin blade to said spider part;

a fifth embodiment mode thereof is characterized in that the resin blade integrally molded to the above-mentioned spider part is provided so as to overlap an adjacent resin blade;

a sixth embodiment mode thereof is characterized in that a spider part is bent forward in a □-shape in the direction of rotation, and an advancing wing-type resin blade, with an outer perimeter end edge that is long and which projects forward in the direction of rotation, is integrally molded to this spider part;

a seventh embodiment mode thereof is characterized in that a spider part is bent forward in a □-shape in the direction of rotation, and an advancing wing-type resin blade, with an outer perimeter end edge that is not long and which projects forward in the direction of rotation, is integrally molded to this spider part;

an eighth embodiment mode thereof is characterized in that one of either a reinforcing rib, reinforcing fin, reinforcing bead or reinforcing beam is provided in the metal disc for the purpose of increasing the rigidity thereof;

a ninth embodiment mode thereof is characterized in that an integrated or separate radiating fin or radiating hole is provided in the metal disc;

a tenth embodiment mode thereof is characterized in that it is configured by the provision of a resin blade attack angle setting part in the metal disc side, and the attachment of a spider part to the attack angle setting part using a rivet or a bolt or the like;

an eleventh embodiment mode thereof is characterized in that the above-mentioned attack angle setting part is integrally or separately formed;

a twelfth embodiment mode thereof is characterized in that one part of the disc-side end part of the resin blade attached by integral molding to the spider part laps against said metal disc;

a thirteenth embodiment mode thereof is, in a fan of a configuration in which each of the resin blades are independently provided on a metal disc, characterized in that it is configured by the attachment of the pertinent spider part for the resin blade, in which the spider part and blade part are formed from the same high-tension resin, to the above-mentioned metal disc using a rivet or a bolt or the like;

a fourteenth embodiment mode thereof is characterized by a configuration in which a metal attachment part is configured from an independent spider part and in which, without the provision of a disc, the above-mentioned resin blades are integrally molded to each spider part in such a way that the blade joint parts are linked in a ring shape;

a fifteenth embodiment mode thereof is characterized in that the above-mentioned spider part is bent forward in a <-shape in the direction of rotation, and an advancing wing-type resin blade, with an outer perimeter end edge that is long and which projects forward in the direction of rotation, is integrally molded to said spider part; and

a sixteenth embodiment mode thereof is characterized in that the above-mentioned spider part is bent forward in a <-shape in the direction of rotation, and an advancing wing-type resin blade, with an outer perimeter end edge that is not long and which projects forward in the direction of rotation, is integrally molded to said spider part.

### BRIEF DESCRIPTION OF THE DIAGRAMS

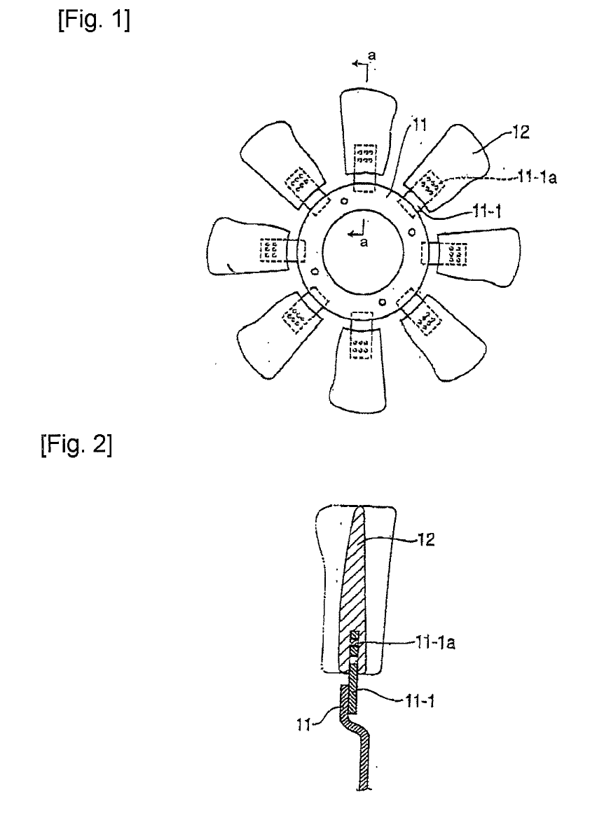

FIG. 1 is a front-surface schematic view showing a first embodiment of the fan comprising resin blades pertaining to the present invention.

FIG. 2 is a vertical cross-section view of the line a-a of FIG. 1.

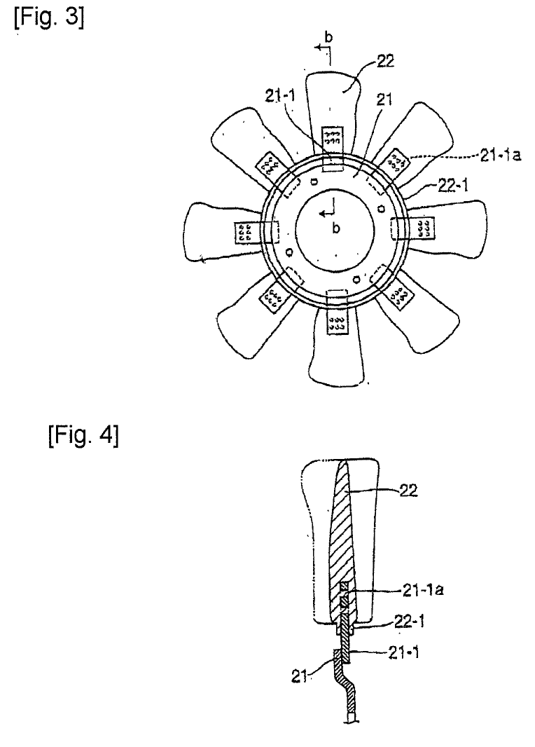

FIG. 3 is a front-surface schematic view showing a second embodiment thereof.

FIG. 4 is a vertical cross-section view of the line b-b of FIG. 3.

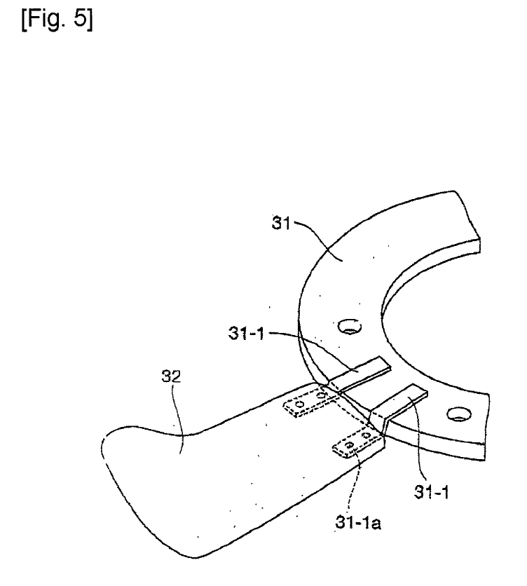

FIG. 5 is a partial perspective schematic view showing a third embodiment thereof.

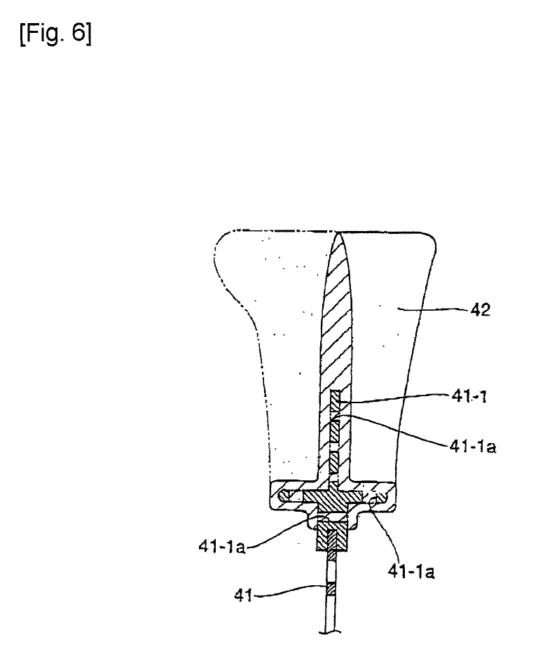

FIG. 6 is a partial cross-section schematic view showing a fourth embodiment thereof.

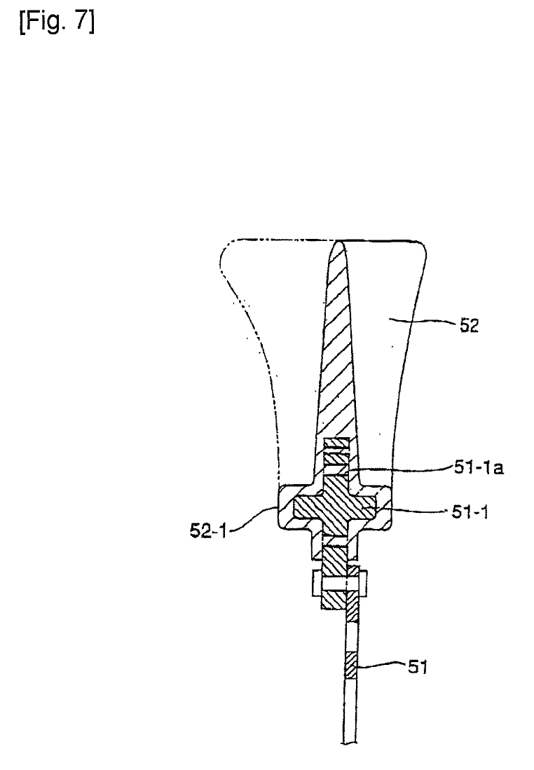

FIG. 7 is a partial cross-section schematic view showing a fifth embodiment thereof.

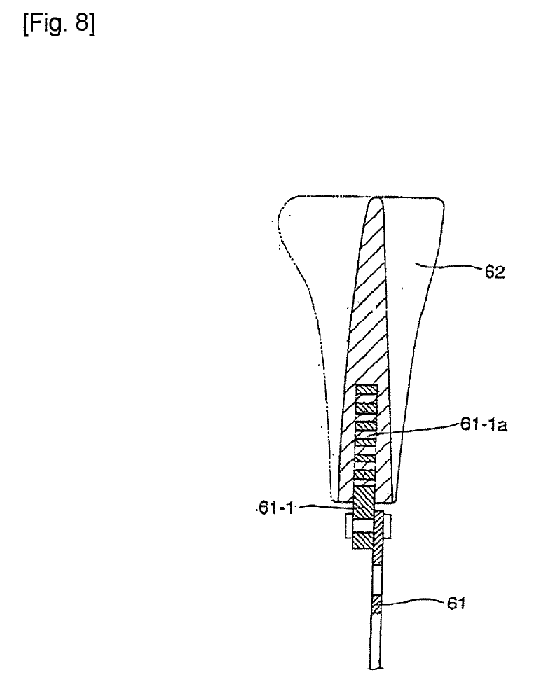

FIG. 8 is a partial cross-section schematic view showing a sixth embodiment thereof.

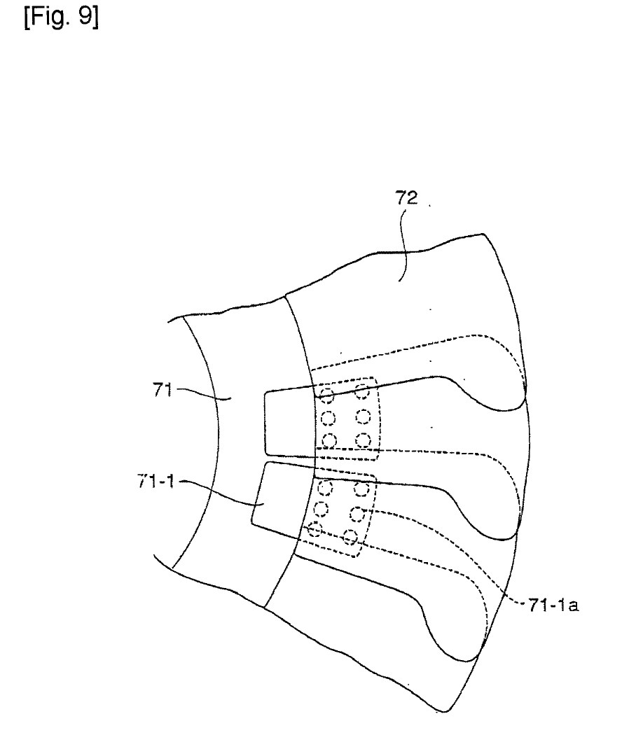

FIG. 9 is a partial front-surface schematic view showing a seventh embodiment thereof.

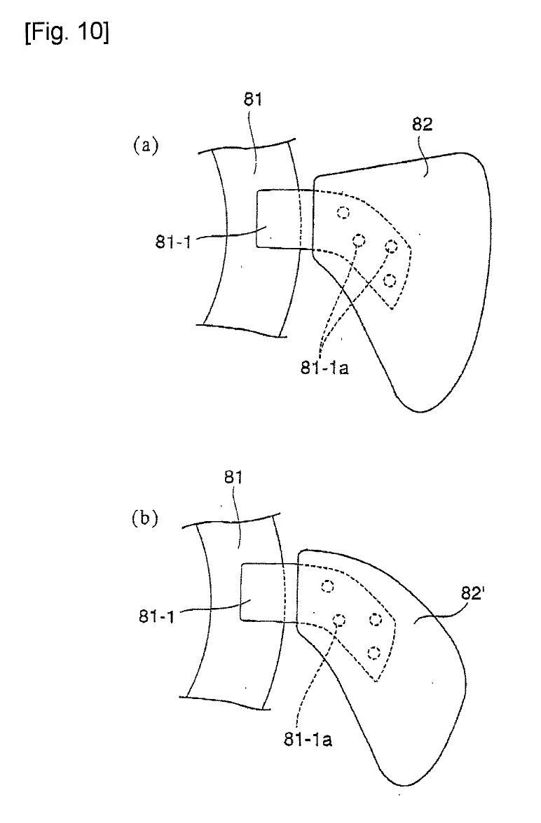

FIG. 10, of which (a) and (b) thereof are partial front-surface schematic views, shows an eighth embodiment thereof.

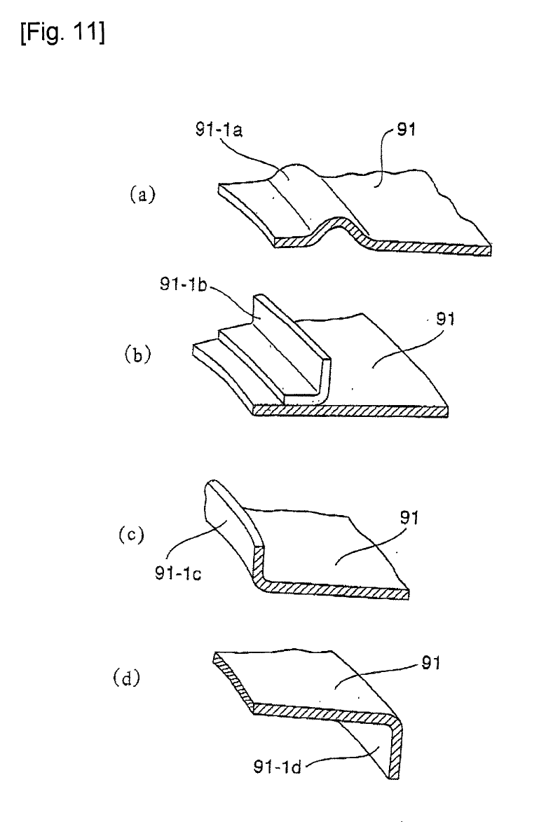

FIG. 11, of which (a), (b), (c) and (d) thereof are partial perspective views, shows a ninth embodiment thereof.

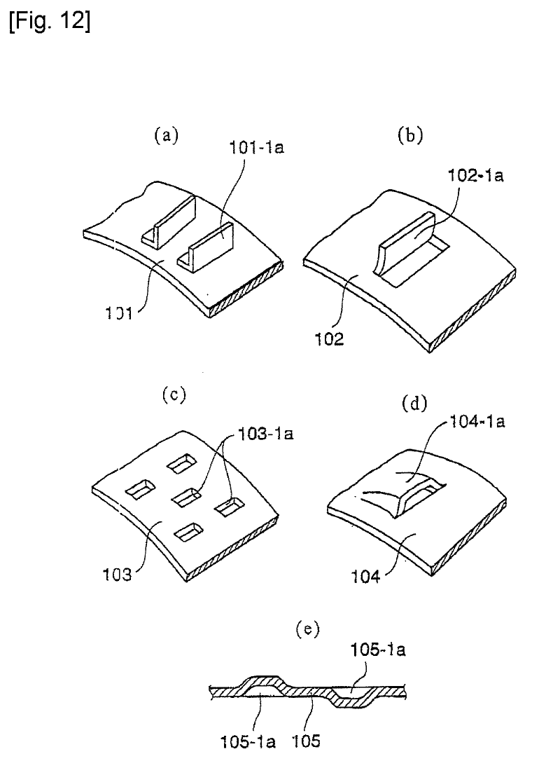

FIG. 12, of which (a), (b), (c) and (d) thereof are partial perspective views, and of which (e) is a partial cross-sectional view, shows a tenth embodiment thereof.

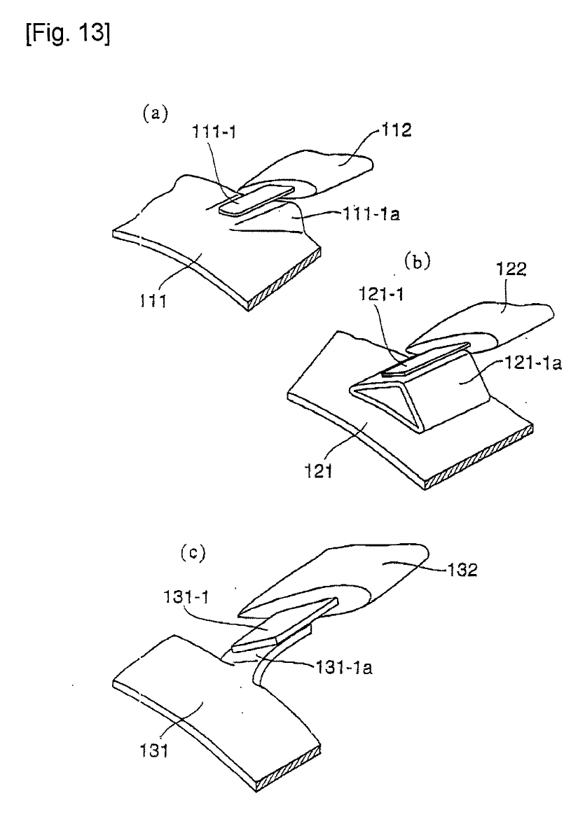

FIG. 13, of which (a), (b) and (c) thereof are partial perspective views, shows an eleventh embodiment thereof.

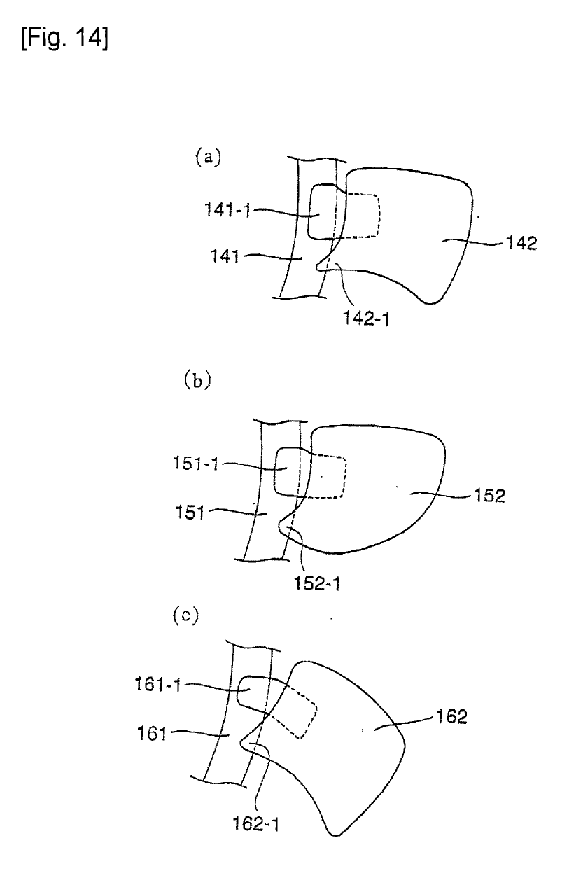

FIG. 14, of which (a), (b) and (c) thereof are partial front-surface schematic views, shows a twelfth embodiment thereof.

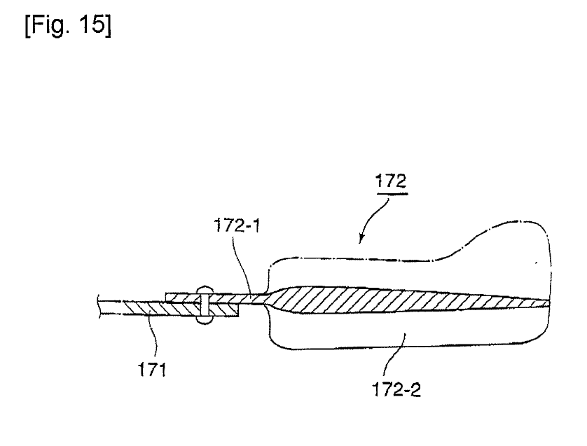

FIG. 15 is a partial cross-section schematic view showing a thirteenth embodiment thereof.

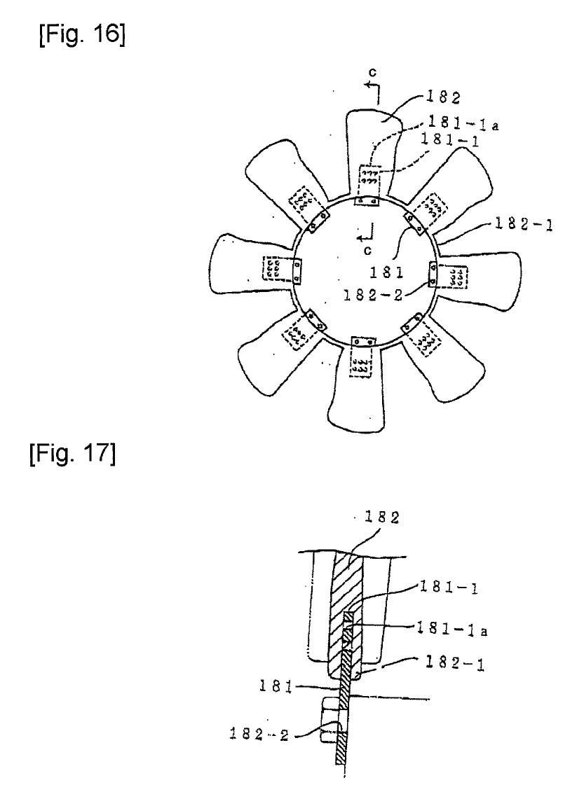

FIG. 16 is a front-surface schematic view showing a fourteenth embodiment thereof.

FIG. 17 is a vertical cross-sectional view along the line c-c of FIG. 16.

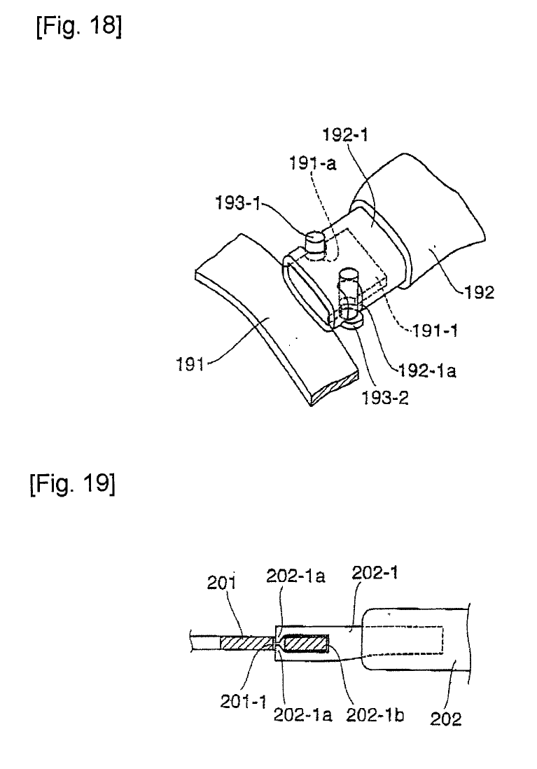

FIG. 18 is a perspective schematic view showing a fifteenth embodiment thereof.

FIG. 19 is a partial cross-section schematic view showing a sixteenth embodiment thereof.

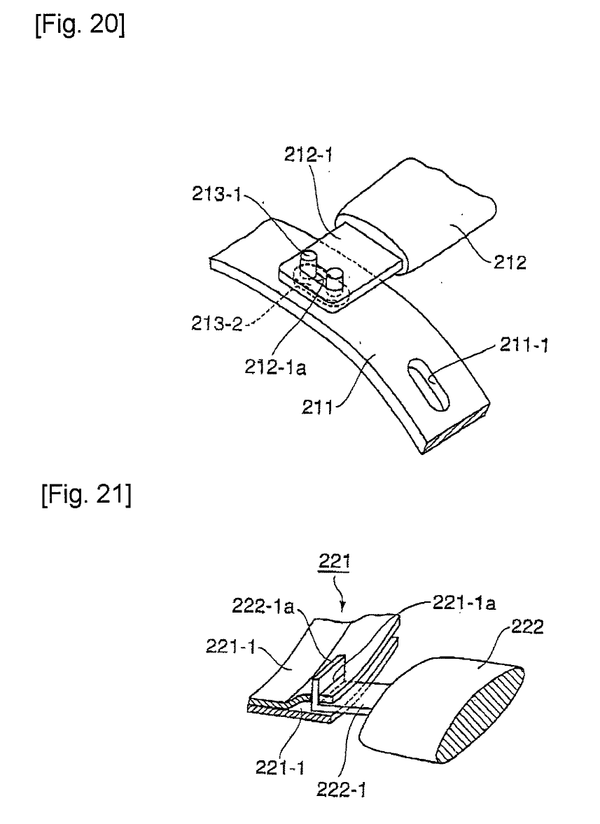

FIG. 20 is a perspective schematic view showing a seventeenth embodiment thereof.

FIG. 21 is a perspective cross-section schematic view showing an eighteenth embodiment thereof.

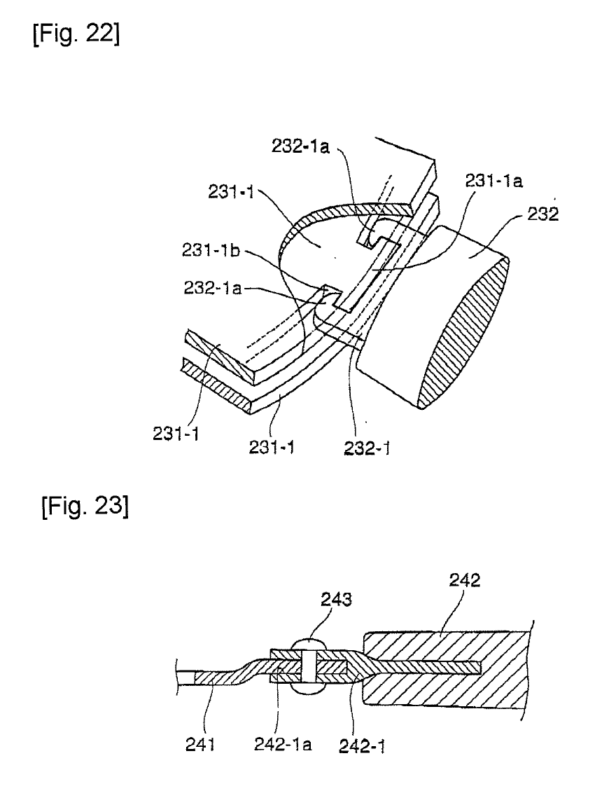

FIG. 22 is a perspective cross-section schematic view showing a partial breakdown of a nineteenth embodiment thereof.

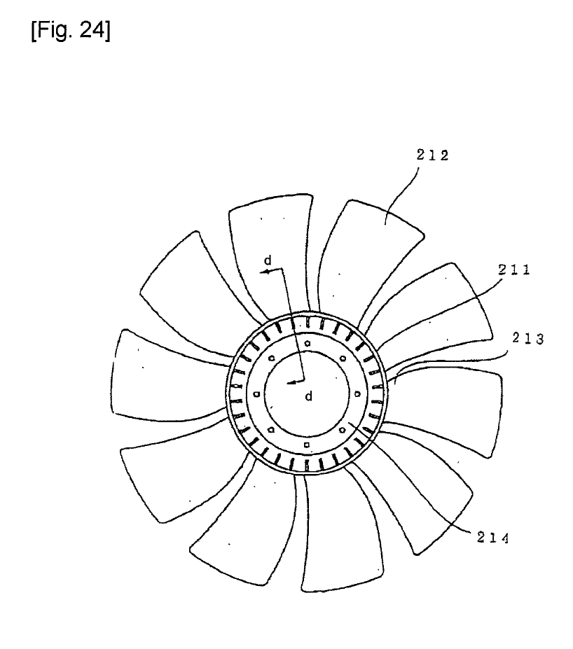

FIG. 23 is a partial cross-section schematic view showing a twentieth embodiment thereof.

FIG. 24 is a front-surface view showing one example of a resin fan of the prior art.

FIG. 25 is a partial expanded cross-section view along the line d-d of FIG. 24.

### EMBODIMENT MODES OF THE INVENTION

In the present invention, the fan comprising resin blades shown in FIG. 1 and FIG. 2, which constitutes a configuration in which each of the above-mentioned resin blades are independently provided on a metal disc, and in which the structure thereof involves the connection of a metal insert-like spider part to a metal disc by welding or the use of a rivet or a bolt or the like and the integral molding of the resin blades to the insert part of said spider part, constitutes a fan configured by the attachment of metal spider parts 11-1 to a plate-like metal annular disc 11 in positions correspondent to each blade by welding or the use of a rivet or a bolt or the like, and the integral molding—either of all blades collectively or each blade individually—of resin blades 12 to an insert part of these spider parts 11-1 and, in this example as well, the resin blades 12 of the fan are attached with a certain attack angle and at a prescribed angle of incline to the center axis. In addition, similarly to that described above, a plurality of through-holes 11-1a are provided in the spider part 11-1, and these through-holes 11-1a are designed to produce an anchoring effect on the injected resin to withstand the tension with respect to the centrifugal forces which act on the blade joint (FIG. 2). It should be further noted that attachment to the annular disc 11 may occur after injection of the resin blade 12 into the insert part of the spider part 11-1.

The fan comprising resin blades shown in FIG. 3 and FIG. 4, which is a variant example of the fan comprising resin blades shown in the above-mentioned FIG. 1 and FIG. 2, constitutes a fan of a configuration in which metal spider parts 21-1 are attached to a plate-like annular disc 21 in positions correspondent to each blade by welding or the use of a rivet or a bolt or the like, and resin blades 22 are integrally molded collectively to an insert part of the spider parts 21-1 in such a way that the blade joint parts thereof are linked in a ring shape; the symbol 22-1 in the diagram refers to this ring part. In this example as well, the resin blades 22 of the fan are attached with a certain attack angle and at a prescribed angle of incline to the center axis. In addition, similarly to that described above, a plurality of through-holes 21-1a are provided in the spider part 21-1, and these through-holes 21-1a produce an anchoring effect on the injected resin to withstand the tension with respect to the centrifugal forces which act on the blade joint (FIG. 4).

The fan comprising resin blades shown in FIG. 5, in which a metal insert-like spider part formed as two pieces at the leading edge and rear edge of one resin blade is attached to a metal disc by welding or the use of a rivet or a bolt or the like and a resin blade is integrally molded to said 2-piece spider part, constitutes a fan in which the metal spider part of one resin blade 32 is configured from two metal spider parts 31-1 which have different bend and draw depth at the leading edge and rear edge, and which is configured by the attachment of this pair of spider parts 31-1 to a plate-like annular disc 31 by welding or the use of a rivet or a bolt or the like, and the integral molding either of all blades collectively or each blade individually—of resin blades 32 to an insert part of the spider parts 31-1. In this example as well, the resin blades 32 of the fan are attached with a certain attack angle and at a prescribed angle of incline to the center axis. In addition, similarly to that described above, a plurality of through-holes 31-1a are provided in the spider part 31-1, and these through-holes 31-1a produce an anchoring effect on the injected resin to withstand the tension with respect to the centrifugal forces that act on the blade joint. Furthermore, the fan of this example, by the adoption of a configuration in which the metal spider part is formed as two pieces for the leading edge and the rear edge, imparts not only a weight reduction effect compared to a 1-piece spider part but also a strength effect with respect to the twist moment which acts on the blade joint part during rotation. It should be noted that the metal spider part 31-1 may constitute a component object of the same shape in which the leading edge and rear edge are turned in reverse. It should also be noted that the resin blade 32 may be molded to the insert part of the spider part 31-1 prior to the attachment of the other end of the spider part 31-1 to the annular disc 31.

The fan comprising resin blades shown in FIG. 6, in which a spider part insert-molded in a metal disc using a high-strength resin of nylon alone or fiber-reinforced PP or nylon is provided, and in which the blade is integrally molded to the insert part of the spider part using a resin that is cheaper and of lower strength than the spider part formed from PP or nylon alone, constitutes a fan configured by the attachment of high-strength resin spider parts 41-1 to a plate-like metal annular disc 41 in positions correspondent to the blades by integral molding, and the collective integral molding of all resin blades 42, which are formed from a resin cheaper and of lower strength than the spider part formed from PP, to the insert part of the spider parts 41-1. That is to say, this fan is one in which the attachment part for an opposing constituent part such as an engine is made from metal, a high-strength resin is used for the blade joint part, and the blade part, on which there is low load, is formed from a low-cost resin. Accordingly, the fan of this example is one in which, by virtue of the fact that the usage amount of the high-cost metal plate and the high-strength resins of, for example, nylon alone or fiber-reinforced PP or nylon, can be reduced, the costs can be reduced and, by virtue of the fact that the difference in thermal expansion coefficient between the respective materials is less, the effects of, for example, a reduction in heat stress and alleviation of stress concentration with respect to external forces such as impact and vibration, are produced.

It should be noted that, in this fan as well, the resin blades 42 of the fan are attached with a certain attack angle and at a prescribed angle of incline to the center axis. In addition, similarly to that described above, a plurality of through-holes 41-1a are provided in the spider part 41-1, and these through-holes 41-1a produce an anchoring effect on the injected resin to withstand the tension with respect to the centrifugal forces which act on the blade joint.

The fan comprising resin blades shown in FIG. 7, in which a high-strength resin spider part is attached to a metal disc using a rivet or a bolt or the like and in which the above-mentioned resin blades are integrally molded to said spider part, constitutes a fan configured by the attachment of, similarly to that described above, high-strength resin spider parts 51-1 formed from nylon alone or fiber-reinforced PP or nylon to a plate-like metal annular disc 51 in positions correspondent to the blades using a rivet or a bolt or the like, and the integral molding to the insert part of the spider part 51-1 of the resin blades 52 either of all blades collectively or each blade individually—formed from a resin cheaper and of lower strength than the resin of the spider part 51-1 formed from, for example, PP or nylon alone. It should be noted that the symbol 52-1 refers to a boss part that is provided in each blade joint part. It should be further noted that the resin blade 52 may be molded to the insert part of the spider part 51-1 prior to the attachment of the other end of the spider part 51-1 to the annular disc 51.

The fan comprising resin blades shown in FIG. 8, which shows a fan which does not comprise the boss part 52-1 of the fan comprising resin blades shown in the above-mentioned FIG. 7, constitutes a fan of a configuration in which a boss part is not provided in each blade joint part but which, the same as the structure of the above-mentioned FIG. 7, is configured by the attachment of, similarly to that described above, high-strength resin spider parts 61-1 formed from nylon alone or fiber-reinforced PP or nylon to a plate-like metal annular disc 61 in positions correspondent to the blades using a rivet or a bolt or the like, and the integral molding in the insert part of the spider part 61-1 of the resin blades 62—either of all blades collectively or each blade individually—formed from a resin cheaper and of lower strength than the resin of the spider part 61-1 formed from, for example, PP or nylon alone. It should be further noted that the resin blade 62 may be molded to the insert part of the spider part 61-1 prior to the attachment of the other end of the spider part 61-1 to the annular disc 61.

The resin blades 52, 62 of the fans comprising resin blades shown in the above-mentioned FIG. 7 and FIG. 8 are respectively attached with a certain attack angle and at a prescribed angle of incline with respect to the center axis. In addition, similarly to that described above, a plurality of through-holes 51-1a, 61-1a are provided in the insert part of the spider parts 51-1, 61-1, and these through-holes 51-1a, 61-1a produce an anchoring effect on the injected resin to withstand the tension with respect to the centrifugal forces which act on the blade joint. Furthermore, in this example as well, in the same way as the fan shown in the above-mentioned FIG. 6, by virtue of the fact that the usage amount of the high-cost metal plate and the high-strength resins of, for example, nylon alone or fiber-reinforced PP or nylon, can be reduced, the costs can be reduced and, by virtue of the fact that the difference in thermal expansion coefficient between the respective materials is less, the effects of, for example, a reduction in heat stress and alleviation of stress concentration with respect to external forces such as impact and vibration, are produced.

The fan comprising resin blades shown in FIG. 9 which is a configuration in which, for example, the resin blade 12 integrally molded in the spider part 11-1 in the fan shown in the above-mentioned FIG. 1 and FIG. 2 is provided so as to overlap an adjacent resin blade 12, constitutes a fan configured by the attachment of metal spider parts 71-1 to a plate-like metal annular disc 71 in positions correspondent to each blade by welding or the use of a rivet or a bolt or the like, and the integral molding of resin blades 72—of all blades collectively or each blade individually—to an insert part of the spider parts 71-1 so that the front-edge side thereof overlaps an adjacent resin blade 72 and so that there is no interval between one blade and another. The resin blades 72 of this fan are respectively attached with a certain attack angle and at a prescribed angle of incline with respect to the center axis. In addition, similarly to that described above, a plurality of through-holes 71-1a are provided in the insert part of the spider part 71-1 and these through-holes 71-1a produce an anchoring effect on the injected resin to withstand the tension with respect to the centrifugal forces which act on the blade joint.

In this example as well, as the overlapping of the resin blades 72 can increase the blade number, the wind volume and wind pressure can be increased, the degree of freedom of the non-uniformity of blade interval can be increased, and a decrease of the pitch noise can be achieved. Furthermore, by virtue of the fact no space exists between the blades, the noise of the engine room which have been projected onto the blade turning surface is caused, as a matter of course, to collide with the rear surface of the blades and to be reflected and returned wherein, by virtue of the fact that there is no direct transmission of noise, the engine noise from the front surface of the vehicle is reduced. Notably, the blades constitute a resin with good vibration absorption characteristics and, therefore, oscillate at times of reflection and are more effective.

The fan comprising resin blades shown in FIG. 10, in which a spider part is bent forward in a □-shape in the direction of rotation and in which a so-called advancing wing-type resin blade, with an outer perimeter end edge that is long and which projects forward in the direction of rotation, is integrally molded in the spider part, or, a so-called advancing wing-type resin blade, with an outer perimeter end edge that is not long and which projects forward in the direction of rotation, is integrally molded to the spider part, shows (a) a fan configured by the attachment of metal spider parts 81-1 bent forward into a <-shape in the direction of rotation to a plate-shaped metal annular disc 81 in positions correspondent to each blade by welding or the use of a rivet or a bolt or the like, and the integral molding of the so-called advancing wing-type resin blades 82, in which the tip end thereof projects forward in the direction of rotation—of all blades collectively or each blade individually—to the insert part of the □-shaped spider parts 81-1, and (b) a fan configured by the attachment of metal spider parts 81-1 bent forward into a □-shape in the direction of rotation on to a plate-shaped metal annular disc 81 in position correspondents to each blade by welding or the use of a rivet or a bolt or the like, and the integral molding of the so-called advancing wing-type resin blades 82′ which have an outer perimeter end edge that is not long and in which the tip end thereof projects forward in the direction of rotation—of all blades collectively or each blade individually—in the insert part of the □-shaped spider parts 81-1 which, similarly to that described above, are attached to the annular disc 81. It should be noted that the resin blades 82 of the fans shown in the above-noted (a) and (b) are attached with a certain attack angle and at a prescribed angle of incline to the center axis. In addition, similarly to that described above, a plurality of through-holes 81-1a are provided in the spider part 81-1, and these through-holes 81-1a produce an anchoring effect on the injected resin to withstand the tension with respect to the centrifugal force that acts on the blade joint.

In the example of the fans shown in the above-noted FIGS. 10(a) and (b), as the blades are of an advancing wing-type, noise reduction is possible and, although a large eccentricity in the wind pressure center in the region of the outer perimeter of the blade exists with respect to the attachment part of the disc and the spider member and a large twist moment is generated in the blade, given that warp can be suppressed to a minimum due to the reinforcing effect provided by the spider part which is curved in the direction of rotation, interference between the blade tip end and the radiator can be prevented and, furthermore, the example of the fan shown in (a) imparts the effect whereby, as the length of the outermost perimeter edge of the blade can be made long, the wind volume can be increased and, the example of the fan shown in (b) imparts the effect whereby, by virtue of the fact that the length of the outermost perimeter edge is not longer than the blade shown in (a), the number of blades can be increased to a number greater than the fan shown in (a) whereby a higher wind pressure can be obtained and, with the mass of the outer perimeter part lessened, high-speed rotation is better able to be withstood.

The fans comprising resin blades shown in FIG. 11 which, in all fans shown in the above-mentioned FIG. 1 to FIG. 10, a reinforcing rib or bead or the like is provided between the attachment holes for the disc and the opposing member to afford an increase in rigidity in order to prevent the fretting wear of said disc at the contact part with the opposing member due to the rise phenomena of the disc produced by the dynamic lift of the blades, constitute (a) a fan in which one part of said disc projects in a concave shape in the circumferential direction on the metal annular disc 91 to form a reinforcing bead 91-1a, and (b) constitutes a fan in which a long reinforcing L-shaped beam 91-1b is attached by welding, soldering or the use of a rivet or a bolt or the like to at least one surface of the same metal annular disc 91 in the circumferential direction. (c) constitutes a fan in which an inner perimeter rib 91-1c is formed on the inner perimeter end edge part of the same metal annular disc 91, and (d) constitutes a fan in which an outer perimeter rib 91-1d is formed on the outer perimeter end edge part of the same metal annular disc 91.

In these fans, as the rigidity is increased by the reinforcement of the area between the opposing member of the disc and the attachment holes using a rib or a bead or the like, almost no rise phenomena of the disc due to the dynamic lift of the blades is produced, wherein fretting wear of the disc can be prevented.

The fans comprising resin blades shown in FIG. 12 which, in all fans shown in the above-mentioned FIG. 1 to FIG. 10, an integrated or separate radiating fin or radiating hole is provided in the disc in order to prevent the heat transmission from said metal disc to the resin blade, respectively show: a fan comprising resin blades shown in FIG. 12(a) which constitutes a fan in which cross-sectional L-shaped fins 101-1a are radially attached by welding, soldering or the use of a rivet or a bolt or the like to at least one surface of the metal disc 101; a fan comprising resin blades shown in (b) thereof which constitutes a fan in which an opened-up like fin 102-1a is radially provided with a hole part in a metal disc 102; a fan comprising resin blades shown in (c) thereof which constitutes a fan in which a plurality of radiating holes 103-1a are provided in a metal disc 103; a fan comprising resin blades shown in (d) thereof which constitutes a fan in which a radiating hole 104-1a is provided by cutting into a metal disc 104; and a fan comprising resin blades shown in (e) thereof which constitutes a fan in which concave/convex parts 105-1a are provided in a metal disc 105.

The fan comprising resin blades shown in FIG. 13, which is a configuration in which an attack angle setting part is provided in the metal disc side and, a simple spider part with fura is attached to the attack angle setting part using a rivet or a bolt the like, respectively show: (a) a fan configured by the provision of an integrated attack angle setting part 111-1a on a metal disc 111 itself by draw processing, and the attachment of a spider part 111-1 to the incline surface of the attack angle setting part 111-1a by welding or the use of a rivet or a bolt or the like, and the integral molding of a resin blade 112 to the insert part of the spider part 111-1; (b) a fan configured by the attachment of a separately configured approximately triangular-shaped cross-section attack angle setting part 121-1a to the metal disc 121 by welding, soldering or the use of a rivet or a bolt or the like, and the attachment of a spider part 121-1 to the incline surface of the attack angle setting part 1211a by welding or the use of a rivet or a bolt or the like, and the integral molding of a resin blade 122 to the insert part of the spider part 121-1; and (c) a fan configured by the provision of a jut-out part (mini-spider) with a prescribed angle twist to a metal disc 131 itself to form an integrated attack angle setting part 131-1a, and the attachment of a spider part 131-1 to the incline surface of the attack angle setting part 131-1a by welding or the use of a rivet or a bolt or the like, and the integral molding of a resin blade 132 to the inner part of the spider part 131-1.

The fans comprising resin blades shown in FIG. 14, which are designed in such a way that, in order to achieve an increase in wind volume by lengthening the real length of the blade joint part, one part of the disc-side end part of the resin blade integrally molded to the spider part in all the fans shown in the above-mentioned FIG. 1 to FIG. 13 are caused to lap against the metal disc, respectively show: (a) a fan in which a resin blade 142, comprising a blade joint part 142-1 that laps against a disc 141, is attached by integral molding to an insert part of a spider part 141-1 attached to the metal disc 141 by welding or the use of a rivet or a bolt or the like; (b) a fan in which a resin blade 152, of a different shape to the blade of the above-mentioned (a) and which comprises a blade joint part 152-1 that laps against a disc 151, is attached by integral molding to the insert part of a spider part 151-1 attached to the metal disc 151 by welding or the use of a rivet or a bolt or the like; and (c) a fan in which a resin blade 162, comprising a blade joint part 162-1 that laps against a disc 161, is attached by integral molding to an insert part of a □-shaped spider part 161-1 attached to the metal disc 161 by welding or the use of a rivet or a bolt or the like.

The fan comprising resin blades shown in FIG. 15 constitutes a fan of a configuration in which a spider part 172-1 of a resin blade 172 with integrated blade and spider parts, and in which the spider part 172-1 and blade part 172-2 are formed from the same high-tension resin, is attached to a metal annular disc 171 using a rivet or a bolt or the like. PPG, N or NG can be employed as the high-tension resin. In this example as well, the integrally molded blade and spider part component is assembled by the simple attachment thereof to the annular disc 171 using a bolt or a rivet or the like wherein, compared to a fan in which a separate spider part is employed, this fan structure is simpler.

The fan comprising resin blades shown in FIG. 16 and FIG. 17, in which a metal or high-strength resin attachment part is configured from an independent insert-like spider part and which is configured by, without the provision of a disc, the collective integral molding of all the resin blades to the spider parts in such a way that the blade joint parts are linked in a ring shape, constitutes a fan of a configuration in which spider parts 181 comprising an insert part 181-1 are concentrically arranged at desired intervals in a circle and, in this state, resin blades 182 are integrally molded to the insert part 181-1 of the spider parts in such a way that the blade joint parts are linked in a ring shape; the symbol 182-1 in the diagram refers to this ring part. In the example of this fan as well, the resin blades 182 are attached with a certain attack angle and at a prescribed angle of incline to the center axis. In addition, similarly to that described above, a plurality of through-holes 181-1a are provided in the spider part 181, and these through-holes 181-1a are designed to produce an anchoring effect on the injected resin to withstand the tension with respect to the centrifugal forces which act on the blade joint. In addition, as attachment holes 182-2 provided in the spider parts 181 are used in this integrated fan, direct attachment using a bolt to an input shaft or the fan coupling apparatus is possible and the use of annular disc of the prior art is unnecessary. It should also be noted that it is not necessary for the structure to comprise the ring part 182-1.

In the fan comprising resin blades shown in FIG. 18 to FIG. 20 which provide illustrative examples of the connection means between the disc and the blade, the fan comprising resin blades shown in FIG. 18 constitutes a fan configured by the assembly of a linking member by the provision of a blade connection protrusion 191-1, in which concave parts 191-1a are formed in both side surfaces thereof, in a metal disc 191 side and, on the other hand, the provision of a space part in a blade 192 side for the fitting-in of the above-mentioned blade connection protrusion 191-1, and, the provision of a resin flat tube-shaped spider part 192-1 comprising, in both side surfaces, convex parts 192-1a correspondent to the above-mentioned concave parts 191-1a, the fitting of the flat tube-shaped spider part 192-1 into the above-mentioned blade connection protrusion 191-1, and the provision of two linking pins 193-1 which are able to be firmly fit-inserted in the above-mentioned concave parts 191-1a and 192-1a to protrude with parallel phase from one plate member 193-2. It will be noted that, in order to remove any rattle in the connection part, the blade connection protrusion 191-1 and flat tube-shaped spider part 192-1 are further affixed using a bolt or the like.

The fan comprising resin blades shown in FIG. 19 constitutes a fan in which connection is afforded by the provision of a joining long hole 201-1, correspondent to the spider part of each blade 202, in a metal disc 201 side and, on the other hand, the provision of a hook part 202-1a, which is fit-inserted into the above-mentioned joining hole 201-1, in the blade 202 side, and, the provision of a spider part 202-1 comprising a slit 202-1b into which the disc 201 is able to be inserted, the fitting of the disc 201 into the slit 202-1b of the spider part 202-1, and the fit-insertion of the hook part 202-1a of the spider part tip end part into the joining hole 201-1 of the disc 201. It will be noted that, in order to remove any rattle between the disc 201 and the spider part 202-1, the disc 201 and spider part 202-1 are further affixed using a bolt or the like.

The fan comprising resin blades shown in FIG. 20 constitutes a fan configured by the assembly of a linking member by the provision of a joining elliptical hole 211-1, correspondent to a spider part 212-1 of each blade 212, in a metal disc 211 side and, on the other hand, the provision, in a blade 212 side, of a spider part 212-1 comprising a joining elliptical hole 212-1a of approximately the same size in a position correspondent to the above-mentioned joining elliptical hole 211-1, the superposing of the spider part 212-1 on the disc 211, and, the provision of two linking pins 213-1 which are able to be firmly fit-inserted in the above-mentioned disc-side joining elliptical hole 211-1 and the spider part side joining elliptical hole 212-1a to protrude in parallel phase from one plate member 213-2. It will be noted that, if the joining elliptical hole 211-1 provided in the disc 211 side were formed as a perfect circle, in such a way that the spider parts do not rotate, the joining holes would be configured as at least two perfect circles. In order to remove any rattle between the disc 211 and the spider part 212-1, the disc 211 and spider part 212-1 are further affixed using a bolt or the like.

The fan comprising resin blades shown in FIG. 21 constitutes a fan in which, using a method for connecting the blades which employs a 2-piece structure disc, connection is afforded by the provision, in the tip-end part of a spider part 222-1 of each blade 222, of a perpendicularly bent latching piece 222-1a, the provision in one disc plate 222-1 of the 2-plate structure disc 221 of a joining hole 221-1a into which the latching piece 222-1a of the above-mentioned spider part 222-1 is able to fit-inserted, the sandwich-like interposing of the spider part 222-1 between the two disc plates 221-1, and the fit-insertion of the latching piece 222-1a provided in the tip-end of said spider part to the joining hole 221-1a provided in the one disc plate 221-1. In the example of this fan as well, in order to remove any rattle between the disc 221 and the spider part 222-1, the disc 221 and the spider part 222-1 are further affixed using a bolt or the like.

The fan comprising resin blades shown in FIG. 22 constitutes a fan in which, using a method for the connection of the blades which employs a 3-piece structure disc, a disc 231 formed from three disc plates 231-1 is integrated by the provision, in both sides of a central disc plate 231-1, of blade connection protrusion holes 231-1a in which concave parts 231-1b are formed and, on the other hand, the provision, in a blade 232 side, of a flat-shaped spider part 232-1 of a thickness approximately the same as said disc plate 231-1 in which a hook 232-1a able to be latched to the above-mentioned concave parts 231-1b is formed and, for the connection thereof, the catching of the hook 232-1a of the spider part 232-1 on the concave part 231-1b of the blade connection protrusion 231-1a of the central disc plate 231-1 and, in this state, the sandwich-like superposing of the remaining two disc plates 231-1 from both sides and the fastening thereof using a bolt or the like. In the example of a fan that employs a 3-piece structure, the two disc plates 231-1 which sandwich the central disc plate 231-1 may be wider than the central disc plate 231-1 so as to cover the connection part between the blade connection protrusion 231-1a and the spider part 232-1 or, disc plates which are of the same width as the central disc plate 231-1, and in which protrusion parts that cover only the connection part between the blade connection protrusion 231-1a and the spider part 232-1 are provided, may be employed. It should be noted that, in the example of this fan, as the connection part between the disc and spider part is integrated with a 3-plate structure disc using a bolt or the like, there is no generation of rattle in the above-mentioned connection part. In addition, the 3-piece structure disc can be one in which the two disc plates are integrated into one plate so as to form a 2-piece structure disc.

The fan comprising resin blades shown in FIG. 23 is a configuration in which, using a method for connection with the disc that employs a connection concave part in the spider part side, the structure thereof is constituted by the formation in the section in question, in which a spider part 242-1 integrally molded with a blade 242 forms a wall thickness thereof, of a concave part 242-1a of a prescribed depth and having a gap almost the same as the thickness of the metal disc 241, the fitting of the concave part 242-1a into a metal disc 241, and the joining of the fitted part using a rivet 243 (or a bolt). It will be noted that, in the example of this fan, as the disc 241 and the spider part 242-1 are affixed using a rivet 243 (or a bolt), there is no generation of rattle in the section in question.

As is described above, the fan comprising resin blades pertaining to the present invention imparts the effects described below.

(1) Unlike the fans of the prior art, as no linked annular boss is provided, individual alteration of each blade is possible in the wake of temperature changes and speed changes whereby, without breakage through the boss part due to centrifugal forces, the durability of the fan is improved.

(2) As no linked annular boss part is provided, the wind volume and wind speed of the cooling wind about the fan coupling apparatus is increased which improves the cooling performance.

(3) As the blade number can be increased by virtue of the fact that the blades are arranged to lap against each other, increases in wind volume and wind pressure are possible, the degree of freedom of the non-uniformity of blade interval is increased, the pitch noise can be reduced and, furthermore, the engine noise from the front surface of the vehicle can be lowered.

(4) By the employment of a spider formed in a □-shape, even if the twist moment that acts on the blades is large, the twisting warp of the blade end can be suppressed to a minimum by the spider member and interference between the blade tip end and the radiator can be prevented. In addition, in the case of a blade with long outer perimeter length, the wind volume can be increased and, furthermore, as the blades are of an advancing wing-type, noise reduction is possible and, furthermore, in the case of a blade in which the outer perimeter length is not long, speed increases, along with an increase in blade number, can be achieved which affords the creation of higher wind pressure.

(5) By the provision of a reinforcing rib and reinforcing bead or the like in the disc, fretting wear due to the dynamic lift of the disc can be prevented.

(6) By the provision of a radiating fin in the disc, heat transmission from the disc to the blade can be prevented, and a lengthening of lifespan thereof is possible.

(7) By the provision of an integrated or separate attack angle setting part in the disc, the attachment of the fan blades is made easier.

(8) As the real length of the blade joint part can be lengthened by virtue of the fact that the blade joint part is caused to lap against the disc, an increase in wind volume is achieved.

(9) By the employment of a resin blade with integrated blade and spider parts, and in which the spider part and blade part are formed from the same high-tension resin, the structure of the fan, compared to a fan which employs a separate spider part, is simplified.

(9) The injection machines used for the molding in each blade can be reduced in size, the mold thereof is smaller, the manufacture is simpler, and the costs are less.

(10) By virtue of the fact that the usage amount of the high cost metal plate and the high-strength resin such as nylon can be reduced, a reduction in costs is possible.

(11) By virtue of the fact that the difference in thermal expansion coefficient between the materials is less, a reduction in heat stress and an alleviation of the concentration of stress with respect to external forces such as impact and vibration is achieved.

1. A fan of a configuration in which each resin blade is independently provided on a metal disc, which fan comprising resin blades is configured by the attachment of a separate metal spider part on to the above-mentioned metal disc by welding or the use of a rivet or a bolt or the like, and the integral molding of the resin blade to said spider part.

2. The fan comprising resin blades of claim 1 in which a metal spider part formed as two pieces at the leading edge and rear edge of one resin blade is attached to a metal disc by welding or the use of a rivet or a bolt or the like, and the resin blade is integrally molded to said 2-piece spider part.

3. A fan of a configuration in which each resin blade is independently provided on a metal disc, which fan comprising resin blades is configured by the integral molding of a high-strength resin spider part to the above-mentioned metal disc, and the integral molding of the above-mentioned resin blade to said spider part.

4. A fan of a configuration in which each resin blade is independently provided on a metal disc, which fan comprising resin blades is configured by the attachment of a high-strength resin spider part to the above-mentioned metal disc using a rivet or a bolt or the like, and the integral molding of the above-mentioned resin blade to said spider part.

5. The fan comprising resin blades of claim 1, wherein the resin blade integrally molded to the above-mentioned spider part is provided so as to overlap the adjacent resin blade.

6. The fan comprising resin blades of claim 1 in which the spider part is bent forward into a □-shape in the direction of rotation, and an advancing wing-type resin blade, which has an outer perimeter end edge that is long and which projects forward in the direction of rotation, is integrally molded to this spider part.

7. The fan comprising resin blades of claim 1 in which the spider part is bent forward into □-shape in the direction of rotation, and an advancing wing-type resin blade, which has an outer perimeter end edge which is not long and which projects forward in the direction of rotation, is integrally molded to this spider part.

8. The fan comprising resin blades of claim 1 in which a reinforcing rib, reinforcing fin, reinforcing bead or a reinforcing beam is provided in the metal disc for the purpose of increasing the rigidity thereof.

9. The fan comprising resin blades of claim 1 in which an integrated or separate radiating fin or radiating hole is provided in the metal disc.

10. The fan comprising resin blades of claim 1 of a configuration in which a resin blade attack angle setting part is provided in the metal disc side, and a spider part is attached to the attack angle setting part using a rivet or a bolt or the like.

11. The fan comprising resin blades of claim 9 in which the above-mentioned attack angle setting part is integrally or separately formed.

12. The fan comprising resin blades of claim 1 in which one part of the disc-side end part of the resin blade attached by integral molding to the spider part laps against said metal disc.

13. A fan of a configuration in which each resin blade is independently provided on a metal disc, which fan comprising resin blades has a configuration in which a pertinent spider part for the resin blade, in which the spider part and blade part are formed from the same high-tension resin, is attached to the above-mentioned metal disc using a rivet or a bolt or the like.

14. A fan comprising resin blades configured by the external insertion of a resin tube-shaped spider part provided in a blade side into a blade connection protrusion formed in a metal disc side, the linking of a blade connection protrusion and tube-shaped spider part by a linking member comprising linking pins, and the affixing of said blade connection protrusion and tube-shaped spider part using a bolt or rivet or the like.

15. A fan comprising resin blades configured by the convex/concave fitting of a resin spider part provided in a blade side into a blade joining hole formed in a metal disc side, and the affixing of the disc and resin spider part using a bolt or rivet or the like.

16. A fan comprising resin blades configured by the connection of a blade joining hole formed in a metal disc side to a blade joining hole provided in a blade side spider part by the through-penetration of linking pins in a state in which the spider part is superposed on the disc, and the affixing of said disc and spider part using a bolt or rivet or the like.

17. A fan comprising resin blades configured by the formation of a metal disc in a 2-piece structure, the insertion of a blade side resin spider part between said two disc plate pieces, the connection by fit-insertion of a latching hook provided in the tip-end of said spider part into a joining hole provided in the disc side, and the affixing of the two disc pieces and the spider part using a bolt or rivet or the like.

18. A fan comprising resin blades configured by the formation of a metal disc in a 3-piece plate structure, the convex/concave fitting and linking of a resin spider part provided in the blade side to a blade connection protrusion formed in the center disc plate, and the fastening of said 3-piece disc plate using a bolt or a rivet in a state in which the center disc plate is sandwiched by the other two disc plates.

19. A fan comprising resin blades configured by the fitting of a concave part formed in the section in question in which a resin spider part provided in the blade side forms the thickness, and the joining of this fitted part using a rivet or a bolt or the like.

20. A fan comprising resin blades of a configuration in which a metal attachment part is configured from an independent spider part and, without the provision of a disc, the above-mentioned resin blade is integrally molded to the spider parts in such a way that the blade joint parts are linked in a ring shape.

21. The fan comprising resin blades of claim 20 in which a spider part is bent forward into a □-shape in the direction of rotation, and an advancing wing-type resin blade, which has an outer perimeter end edge that is long and which projects forward in the direction of rotation, is integrally molded to this spider part.

22. The fan comprising resin blades of claim 1 in which a spider part is bent forward into a □-shape in the direction of rotation, and an advancing wing-type resin blade, which has an outer perimeter end edge which is not long and which projects forward in the direction of rotation, is integrally molded to this spider part.
